(19) United States
(12) Patent Application Publication
(10) Pub. No.: US 2015/0277114 A1
(43) Pub. Date: Oct. 1, 2015

(54) SYSTEM AND METHOD FOR A VEHICLE SYSTEM USING A HIGH SPEED NETWORK

(71) Applicant: FORD GLOBAL TECHNOLOGIES, LLC, Dearborn, MI (US)

(72) Inventors: Michael Raymond WESTRA, Plymouth, MI (US); Nicholas COLELLA, Grosse Ile, MI (US); Cameron SMYTH, South Lyon, MI (US); Zachary CHURCH, Dearborn, MI (US); Brett STOTTLEMYER, Southfield, MI (US)

(73) Assignee: FORD GLOBAL TECHNOLOGIES, LLC, Dearborn, MI (US)

(21) Appl. No.: 14/227,565

(22) Filed: Mar. 27, 2014

(51) Int. Cl. G02B 27/01; B60K 35/00; G01C 21/26

(52) U.S. Cl. CPC G02B 27/01; G01C 21/265; B60K 35/00; B60K 2350/1056; B60K 2350/1076; B60K 2350/1024; B60K 2350/1044; G02B 2027/0187

(57) ABSTRACT

A non-transitory computer readable storable medium, storing instruction that, when executed by a processor, configure the processor to establish a communication connection with a vehicle navigation system. The processor may receive graphical moving map data from the navigation system at a primary interface. The processor may stream the graphical moving map data to a vehicle dash display and update the vehicle dash display based on the graphical moving map data. The processor may output the graphical moving map data at the vehicle dash display.

### TECHNICAL FIELD

The present disclosure general relates to the field of networked computerized infotainment system. More particularly, the present disclosure relates to a vehicle computing system using a high speed network to manage data between one or more control modules communicating with the system.

### BACKGROUND

U.S. Patent Application 2008/0092131 discloses a system for facilitating centralized management of human machine interface (HMI) components distributable across multiple nodes of the system. The system includes centralized configuration storage for managing a set of HMI templates deployable to a set of remote nodes including HMI facilities. The deployed HMI instances are thereafter executed upon the remote nodes. An HMI application import utility receives HMI applications that are not in a form suitable for management in the centralized configuration storage facility. The import utility encapsulates the received HMI applications to render the HMI templates that are suitable for the centralized configuration storage facility.

European Patent EP1873633 discloses web components that are leveraged to provide a dynamic distributed automation control system human machine interface (HMI) based on a graphical user interface (GUI) function block networks. The Web components run within a Web browser, allowing for dynamic control and/or monitoring of automation control system devices from remote locations—without requiring additional software and/or computing resources to be installed. In one instance, a generic Web component is utilized to create specialized Web components utilizing parameters supplied by hypertext markup language (HTML) pages.

### SUMMARY

In at least one embodiment, a method for managing display data in a vehicle computing system having one or more controllers communicating in an Ethernet network. The method may establish communication with a remote server using a transceiver. The method may receive a display configuration for a primary interface at the transceiver from the remote server. The method may output the display configuration at the primary interface. The method may communicate the display configuration to a vehicle dash display. The method may reconfigure the vehicle dash display based on the display configuration and output the display configuration at the vehicle dash display.

In at least one embodiment, a vehicle infotainment system comprising one or more controllers having a transceiver to communicate with at least one data source. The one or more controllers configured to receive graphical user interface data at a first interactive display from the at least one data source and communicate the graphical user interface data to a heads-up display. The vehicle infotainment system may reconfigure the heads-up display based on the graphical user interface and output the graphical user interface data at the heads-up display.

In at least one embodiment, in at least one embodiment, a non-transitory computer readable storable medium, storing instruction that, when executed by a processor, configure the processor to establish a communication connection with a vehicle navigation system. The processor may receive graphical moving map data from the navigation system at a primary interface. The processor may stream the graphical moving map data to a vehicle dash display and update the vehicle dash display based on the graphical moving map data. The processor may output the graphical moving map data at the vehicle dash display

### BRIEF DESCRIPTION OF THE DRAWINGS

FIG. 1 is an exemplary block topology of a vehicle infotainment system implementing a user-interactive vehicle information display system according to an embodiment;

FIG. 2 is an exemplary block topology of a vehicle computing system transmitting data to an instrument display using one or more communication technologies according to an embodiment;

FIG. 3 is an exemplary block topology of a vehicle computing system communicating with a display according to an embodiment;

FIG. 4 is an exemplary block topology of one or more displays being reconfigured by a primary interactive display in a vehicle computing system according to an embodiment;

FIG. 5 is a flow chart illustrating a method of a primary interactive display configuring one or more secondary displays in a vehicle computing system according to an embodiment;

FIG. 6 is a flow chart illustrating the management of data between one or more modules in a vehicle computing system according to an embodiment; and

FIG. 7 is a flow chart illustrating the management of graphical user interface data in a vehicle computing system according to an embodiment.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the embodiments. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

The embodiments of the present disclosure generally provide for a plurality of circuits or other electrical devices. All references to the circuits and other electrical devices and the functionality provided by each, are not intended to be limited to encompassing only what is illustrated and described herein. While particular labels may be assigned to the various circuits or other electrical devices disclosed, such labels are not intended to limit the scope of operation for the circuits and the other electrical devices. Such circuits and other electrical devices may be combined with each other and/or separated in any manner based on the particular type of electrical implementation that is desired. It is recognized that any circuit or other electrical device disclosed herein may include any number of microprocessors, integrated circuits, memory devices (e.g., FLASH, random access memory (RAM), read only memory (ROM), electrically programmable read only memory (EPROM), electrically erasable programmable read only memory (EEPROM), or other suitable variants thereof) and software which co-act with one another to perform operation(s) disclosed herein. In addition, any one or more of the electric devices may be configured to execute a computer-program that is embodied in a non-transitory computer readable medium that is programmed to perform any number of the functions as disclosed.

A vehicle computing system may be limited in the transport and display of content using a controller area network (herein known as CAN) because of the limited bandwidth. For example, the CAN network may not be able to provide graphical moving maps data transmitted from one module to a display. In another example, the CAN network may not be able to transmit a music album art from one computer module to one or more outputs in communication with the vehicle computing system. The vehicle network may communicate an increased amount of data for output at the infotainment system at much higher speeds with the use of higher speed networking techniques (e.g., Ethernet networking technology, Media Oriented System Transport networking technology, etc. . . . ). The higher speed network configured with the vehicle computing system may enable a dynamic update of data to the one or more outputs including, but not limited to, music/audio, navigation, and more. The one or more outputs may include human machine interface (HMI) displays and/or graphical user interface (GUI) displays.

The higher speed networking techniques integrated with a vehicle computing system may allow for data to be communicated to one or more HMI outputs that may reconfigure the display, operation, and/or content of the HMI. The one or more HMI outputs that are integrated with a CAN network, and/or other low speed networks, are usually static outputs/displays that cannot be updated unless the vehicle computing system and the HMI hardware are flashed with a software update. The use of the higher speed networking techniques with the vehicle computing system may allow for a reduction of hardware components at the one or more HMI outputs in communication with the vehicle computing system, transmit data that may reconfigure an HMI display, and/or a combination therein. For the vehicle computing system described herein, a high speed networking configuration to manage data and reconfigure one or more displays can be realized as discussed below.

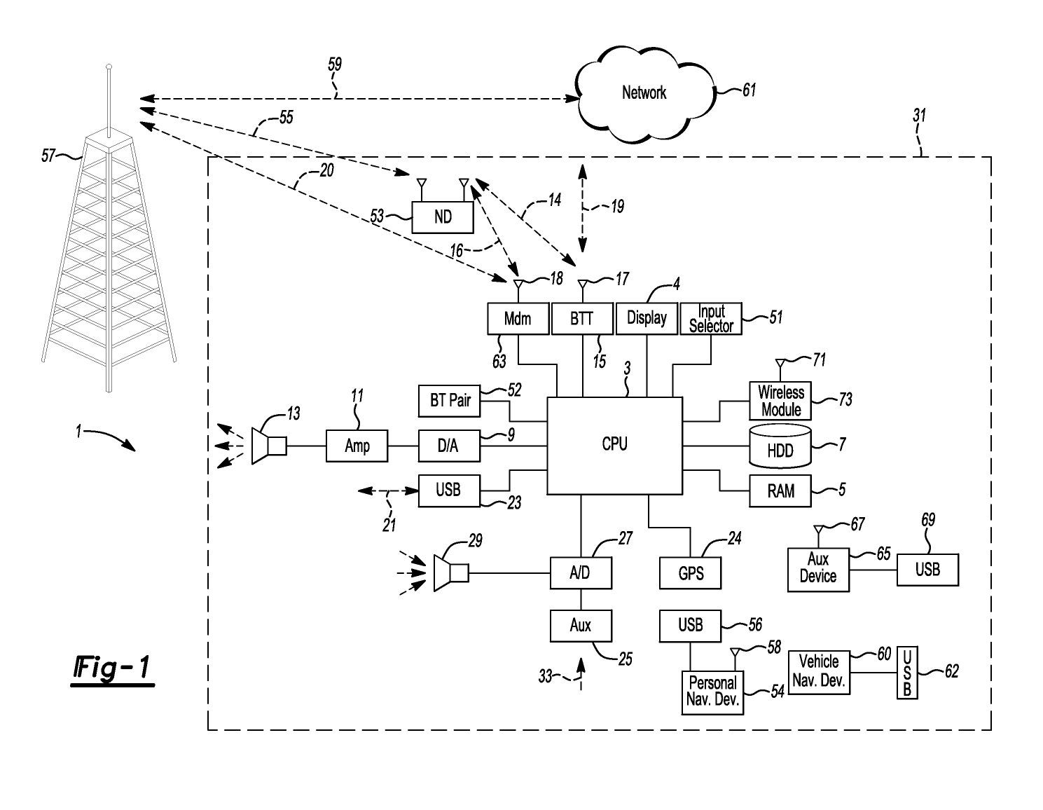

FIG. 1 illustrates an example block topology for a vehicle based computing system 1 (VCS) for a vehicle 31. An example of such a vehicle-based computing system 1 is the SYNC system manufactured by THE FORD MOTOR COMPANY. A vehicle enabled with a vehicle-based computing system may contain a visual front end interface 4 located in the vehicle. The user may also be able to interact with the interface if it is provided, for example, with a touch sensitive screen. In another illustrative embodiment, the interaction occurs through, button presses, spoken dialog system with automatic speech recognition and speech synthesis.

In the illustrative embodiment 1 shown in FIG. 1, a processor 3 controls at least some portion of the operation of the vehicle-based computing system. Provided within the vehicle, the processor allows onboard processing of commands and routines. Further, the processor is connected to both non-persistent 5 and persistent storage 7. In this illustrative embodiment, the non-persistent storage is random access memory (RAM) and the persistent storage is a hard disk drive (HDD) or flash memory. In general, persistent (non-transitory) memory can include all forms of memory that maintain data when a computer or other device is powered down. These include, but are not limited to, HDDs, CDs, DVDs, magnetic tapes, solid state drives, portable USB drives and any other suitable form of persistent memory.

The processor is also provided with a number of different inputs allowing the user to interface with the processor. In this illustrative embodiment, a microphone 29, an auxiliary input 25 (for input 33), a USB input 23, a GPS input 24, screen 4, which may be a touchscreen display, and a BLUETOOTH input 15 are all provided. An input selector 51 is also provided, to allow a user to swap between various inputs. Input to both the microphone and the auxiliary connector is converted from analog to digital by a converter 27 before being passed to the processor. Although not shown, numerous of the vehicle components and auxiliary components in communication with the VCS may use a vehicle network (such as, but not limited to, a Ethernet network) to pass data to and from the VCS (or components thereof).

Outputs to the system can include, but are not limited to, a visual display 4 and a speaker 13 or stereo system output. The speaker is connected to an amplifier 11 and receives its signal from the processor 3 through a digital-to-analog converter 9. Output can also be made to a remote BLUETOOTH device such as PND 54 or a USB device such as vehicle navigation device 60 along the bi-directional data streams shown at 19 and 21 respectively.

In one illustrative embodiment, the system 1 uses the BLUETOOTH transceiver 15 to communicate 17 with a user's nomadic device 53 (e.g., cell phone, smart phone, PDA, or any other device having wireless remote network connectivity). The nomadic device can then be used to communicate 59 with a network 61 outside the vehicle 31 through, for example, communication 55 with a cellular tower 57. In some embodiments, tower 57 may be a WiFi access point.

Exemplary communication between the nomadic device and the BLUETOOTH transceiver is represented by signal 14.

Pairing a nomadic device 53 and the BLUETOOTH transceiver 15 can be instructed through a button 52 or similar input. Accordingly, the CPU is instructed that the onboard BLUETOOTH transceiver will be paired with a BLUETOOTH transceiver in a nomadic device.

Data may be communicated between CPU 3 and network 61 utilizing, for example, a data-plan, data over voice, or DTMF tones associated with nomadic device 53. Alternatively, it may be desirable to include an onboard modem 63 having antenna 18 in order to communicate 16 data between CPU 3 and network 61 over the voice band. The nomadic device 53 can then be used to communicate 59 with a network 61 outside the vehicle 31 through, for example, communication 55 with a cellular tower 57. In some embodiments, the modem 63 may establish communication 20 with the tower 57 for communicating with network 61. As a non-limiting example, modem 63 may be a USB cellular modem and communication 20 may be cellular communication.

In one illustrative embodiment, the processor is provided with an operating system including an API to communicate with modem application software. The modem application software may access an embedded module or firmware on the BLUETOOTH transceiver to complete wireless communication with a remote BLUETOOTH transceiver (such as that found in a nomadic device). Bluetooth is a subset of the IEEE 802 PAN (personal area network) protocols. IEEE 802 LAN (local area network) protocols include WiFi and have considerable cross-functionality with IEEE 802 PAN. Both are suitable for wireless communication within a vehicle. Another communication means that can be used in this realm is free-space optical communication (such as IrDA) and non-standardized consumer IR protocols.

In another embodiment, nomadic device 53 includes a modem for voice band or broadband data communication. In the data-over-voice embodiment, a technique known as frequency division multiplexing may be implemented when the owner of the nomadic device can talk over the device while data is being transferred. At other times, when the owner is not using the device, the data transfer can use the whole bandwidth (300 Hz to 3.4 kHz in one example). While frequency division multiplexing may be common for analog cellular communication between the vehicle and the internet, and is still used, it has been largely replaced by hybrids of Code Domain Multiple Access (CDMA), Time Domain Multiple Access (TDMA), Space-Domain Multiple Access (SDMA) for digital cellular communication. These are all ITU IMT-2000 (3G) compliant standards and offer data rates up to 2 mbs for stationary or walking users and 385 kbs for users in a moving vehicle. 3G standards are now being replaced by IMT-Advanced (4G) which offers 100 mbs for users in a vehicle and 1 gbs for stationary users. If the user has a data-plan associated with the nomadic device, it is possible that the data-plan allows for broad-band transmission and the system could use a much wider bandwidth (speeding up data transfer). In still another embodiment, nomadic device 53 is replaced with a cellular communication device (not shown) that is installed to vehicle 31. In yet another embodiment, the ND 53 may be a wireless local area network (LAN) device capable of communication over, for example (and without limitation), an 802.11g network (i.e., WiFi) or a WiMax network.

In one embodiment, incoming data can be passed through the nomadic device via a data-over-voice or data-plan, through the onboard BLUETOOTH transceiver and into the vehicle's internal processor 3. In the case of certain temporary data, for example, the data can be stored on the HDD or other storage media 7 until such time as the data is no longer needed.

Additional sources that may interface with the vehicle include a personal navigation device 54, having, for example, a USB connection 56 and/or an antenna 58, a vehicle navigation device 60 having a USB 62 or other connection, an onboard GPS device 24, or remote navigation system (not shown) having connectivity to network 61. USB is one of a class of serial networking protocols. IEEE 1394 (FireWire™ (Apple), i.LINK™ (Sony), and Lynx™ (Texas Instruments)), EIA (Electronics Industry Association) serial protocols, IEEE 1284 (Centronics Port), S/PDIF (Sony/Philips Digital Interconnect Format) and USB-IF (USB Implementers Forum) form the backbone of the device-device serial standards. Most of the protocols can be implemented for either electrical or optical communication.

Further, the CPU could be in communication with a variety of other auxiliary devices 65. These devices can be connected through a wireless 67 or wired 69 connection. Auxiliary device 65 may include, but are not limited to, personal media players, wireless health devices, portable computers, and the like.

Also, or alternatively, the CPU could be connected to a vehicle based wireless router 73, using for example a WiFi (IEEE 803.11) 71 transceiver. This could allow the CPU to connect to remote networks in range of the local router 73.

In addition to having exemplary processes executed by a vehicle computing system located in a vehicle, in certain embodiments, the exemplary processes may be executed by a computing system in communication with a vehicle computing system. Such a system may include, but is not limited to, a wireless device (e.g., and without limitation, a mobile phone) or a remote computing system (e.g., and without limitation, a server) connected through the wireless device. Collectively, such systems may be referred to as vehicle associated computing systems (VACS). In certain embodiments particular components of the VACS may perform particular portions of a process depending on the particular implementation of the system. By way of example and not limitation, if a process has a step of sending or receiving information with a paired wireless device, then it is likely that the wireless device is not performing the process, since the wireless device would not “send and receive” information with itself. One of ordinary skill in the art will understand when it is inappropriate to apply a particular VACS to a given solution. In all solutions, it is contemplated that at least the vehicle computing system (VCS) located within the vehicle itself is capable of performing the exemplary processes.

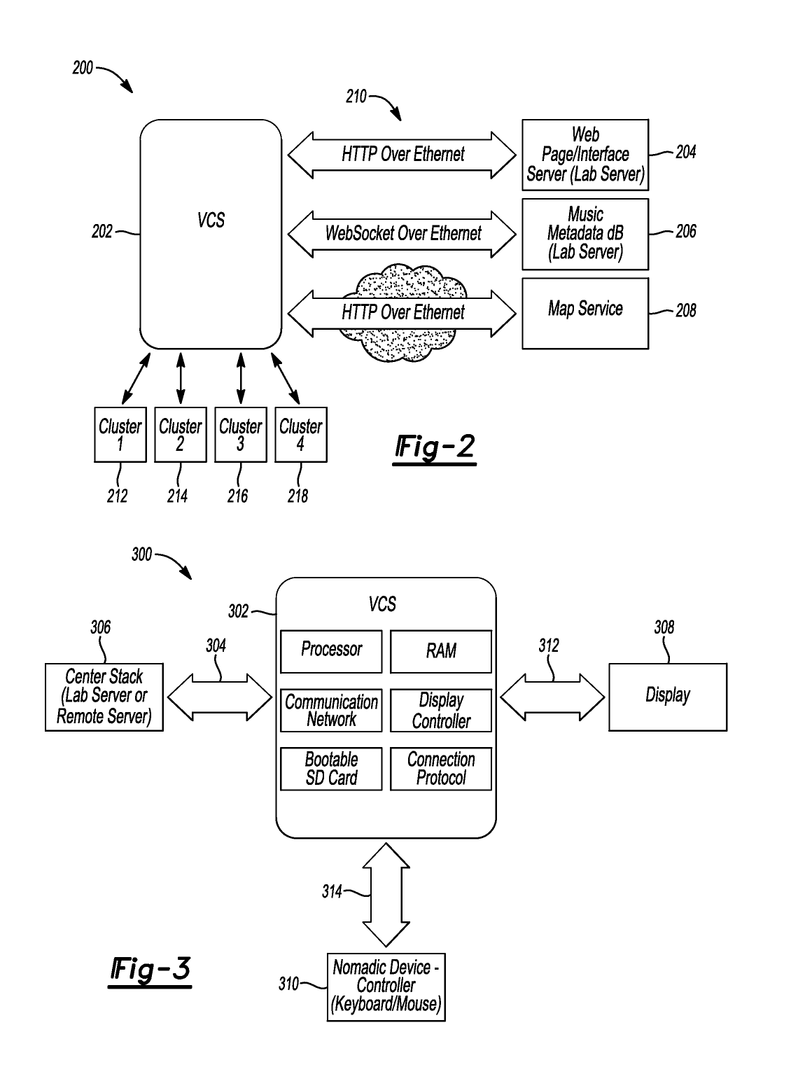

FIG. 2 is an exemplary block topology of a VCS 202 streaming data to an instrument display using one or more structured data transport methods 210 over a high speed communication network according to an embodiment. In this embodiment as show in FIG. 2, the VCS 202 may have one or more processors (i.e., controllers) to operate an infotainment system. The infotainment system may be in communication with one or more instrument displays. The instrument displays may include, but is not limited to, a center stack display 212, an instrument cluster display 214, a heads-up display 216, and/or a rear seat entertainment display 218.

The VCS 202 may manage the display between one or more modules that make up the infotainment system. The data transmitted for output at the one or more displays may include, but is not limited to, HMI definition, runnable model, sandboxed code, music/audio metadata, moving maps for navigation purposes, and/or navigation directions including an intersection-level map display. For example, the VCS 202 may manage the communication of the data transported from the center stack display 212 to the instrument cluster 214 and/or heads-up display 216. The data managed may further include, but is not limited to, battery electric power status/charge schedule for a hybrid powertrain, vehicle settings, voice HMI instructions, and/or notifications for calls. In another example, the VCS 202 may be able to manage color and/or animations during the driving experience on all displays in communication with the infotainment system. The VCS 202 may manage and output a common color and/or animation to align the displays seamlessly.

The VCS 202 may manage the one or more structured data transport methods based on a networking interface strategy. The networking interface strategy may determine how to communicate/transport data from a data source to one or more displays based on several factors including, but not limited to, data content, remote server, and/or infotainment hardware.

In one embodiment, the vehicle system 202 may transmit a hyper-text transfer protocol (herein known as HTTP) request over Ethernet 210 to a remote server 204 hosting web pages and interfaces. The HTTP request may allow the VCS 202 to upload the web page 204 and/or data from the webpage 204 for output at the infotainment system. For example, the VCS 202 may transmit an HTTP request over Ethernet to a map service 208 to retrieve navigation map tiles and application programming interfaces (APIs). The VCS 202 may transmit the navigation map tiles to one or more displays including the instrument cluster display 214. Based on the selected map API, the presented map data at the instrument cluster display 214 may allow the system to zoom in/out, reorient the map in one of the orthogonal directions, and/or present required objects on the map.

In another example, the VCS 202 may request for audio data from a music metadata database 206 using a Websocket format over Ethernet 210. The Webscoket request over Ethernet 210 to a music metadata database 206 may allow the VCS 202 to receive audio data including, but not limited to, album art, track title, artist name, album name, time of track progress, time remaining in track, a progress bar measuring track progress, and simulating the play of an audio track. The VCS 202 may transmit the received audio data to one or more displays and/or outputs of the infotainment system using the high speed communication network. In another example, the VCS 202 may request audio data from a music metadata database 206 using several methods including, but not limited to, a Qt modeling language with JavaScript object notation (JSON) metadata and/or remote frame buffers.

The VCS 202 may manage and transmit the received audio data to the center stack display 212 for output. The VCS 202 may receive a request for audio data from the heads-up 216 display, and based on that request the VCS 202 may transmit the audio data to the heads-up display 216.

FIG. 3 is an ‘exemplary block topology 300 of a vehicle computing system 302 communicating data to at least one display 308 according to an embodiment. In this embodiment as shown in FIG. 3, the VCS 302 may include, but is not limited to, a processor, RAM and ROM memory, a display controller, a transceiver, and a high speed communication network. The high speed communication network may include, but is not limited to, an Ethernet network, a MOST network, and/or a wireless network.

The VCS 302 may establish a connection using the transceiver with a nomadic device 310. The transceiver may include, but is not limited to, wired and/or wireless technology. An example of a wired connection using the transceiver may include universal serial bus (USB) technology. An example of a wireless connection may include, but is not limited to, Bluetooth, Low Energy Bluetooth, and/or near field communication. The nomadic device 310 may act as a bridge to communicate 314 with third party providers including, but not limited to, remote servers and databases. The nomadic device 310 may also have one or more software application that may be in communication with the VCS 302. The VCS 302 may receive data from the nomadic device 310 and output the received data to at least one display 308.

For example, the VCS 302 may receive data from the nomadic device 310 and transmit the received data to at least one display 308 and/or a speaker (not shown). The data may include, but is not limited to, audio prompts, HMI art/buttons/icons, phone contact pictures, and/or turn icons/images/road-signs. If the VCS 302 receives audio data, the audio data may include, but is not limited to, album art which may be reconfigured by the VCS 302 and transmitted 312 for output at the display 308.

The VCS 302 may establish communication 312 with a display 308 using a video graphics array (VGA) connector. The display 308 may include, but is not limited to, a touch screen liquid crystal display. In another embodiment, the display 308 may include a wireless remote HMI. The display 308 may transmit a message to the VCS 302 requesting any new updates including new configurations for output.

For example, the VCS 302 may communicate 304 with a remote server 306 and receive a new feature display that may reconfigure the at least one display 308. The new feature display may be transmitted 312 to the display 308. The display 308 may reconfigure the output to include the new feature. In another example, the VCS 302 may receive a new visual and pallet/theme to transmit to the at least one display 308 in communication with the system.

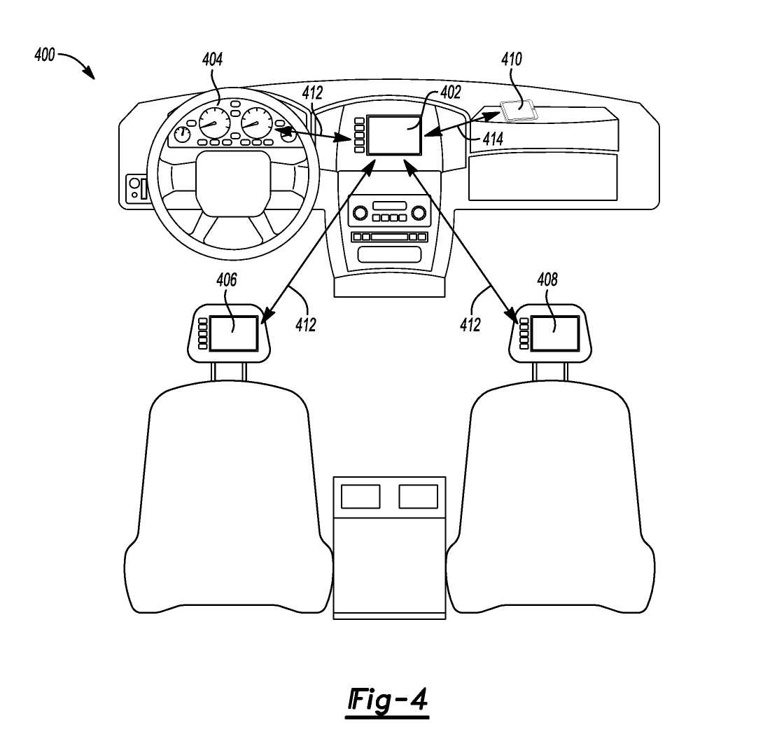

FIG. 4 is an exemplary block topology of one or more displays being reconfigured by a primary interactive display 402 in a vehicle computing system according to an embodiment. The one or more displays may make up a vehicle infotainment system 400. The vehicle infotainment system 400 may be communicating with one or more controllers that make up the VCS. The infotainment system 400 may be communicating with one or more controller using an Ethernet network strategy. The infotainment displays in a vehicle may include, but is not limited to, a primary interface display 402, a vehicle dash display 404 (i.e., a secondary interface display), and one or more rear seat entertainment displays 406, 408.

In one embodiment, the infotainment displays may each have one or more embedded controllers used to communicate with the VCS. For example, the VCS may receive a new feature to be presented at the one or more displays. The new feature may require the primary user interface display 402 (e.g., center stack display) to be flashed with new software instructions. The new software instructions may reconfigure the primary user interface 402 to display the new feature. If the vehicle computing system has a low speed network, such as a CAN Bus network, to communicate between the one or more modules and/or displays, each display may have to be separately flashed with new software instructions so that each display may be reconfigured to present the new feature. If the vehicle computing system has implemented a high speed network, such as an Ethernet network, the VCS may receive the new software instructions at the primary user interface 402 to reconfigure the display for presenting the new feature. The primary user interface 402 may communicate 412 the new feature display to the one or more additional displays in the infotainment system 400 without having to flash each display module with the new software instructions.

In one embodiment, the primary interface display includes one or more virtual machines and virtual embedded control units for managing the display configuration to the one or more additional displays. The virtual machines and virtual embedded control units may isolate/protect the one or more displays from receiving the new feature.

The Ethernet network may allow the primary user interface display 402 to communicate 412 the new feature to the additional displays so that they may be reconfigured to output/present the new feature. The VCS having a high speed network enables the system to get the HMI at runtime as needed. The VCS may also manage whether or not a particular display is updated based on the data/feature received. For example, one or more safely driven HMI(s) may be isolated form these reconfigurations.

In another embodiment, an infotainment system 400 having one or more displays in communication with the VCS using an Ethernet network may have one control module used to manage and/or control the one or more displays. The infotainment system 400 may be able to have the VCS manage the displays instead of each display having its own module. For example, the Ethernet network may allow the VCS to receive display data from one or more sources including, but not limited to, a remote server that may be communicating data through a nomadic device 410 connected 414 to the system. The end destination of the data may be the vehicle dash display 404, and the VCS may communicate 412 the data remotely to the display 404 using the high speed network connection.

In another example, a nomadic device 410 may have a navigation application providing graphical user interface data including destination directions to a particular location. The graphical user interface data may include, but is not limited to, graphical moving map data that illustrates a route to the destination. The nomadic device 410 transmitting the graphical user interface data may be in communication 414 with the VCS using Bluetooth technology. The VCS may receive 414 the graphical user interface data from the nomadic device 410. The VCS may communicate 412 the graphical user interface data to one or more infotainment system display screens using the high speed network. For example, the VCS may communicate the graphical user interface data to a heads-up display unit (not shown), allowing the reconfiguration of the heads-up display to output the graphical moving map data.

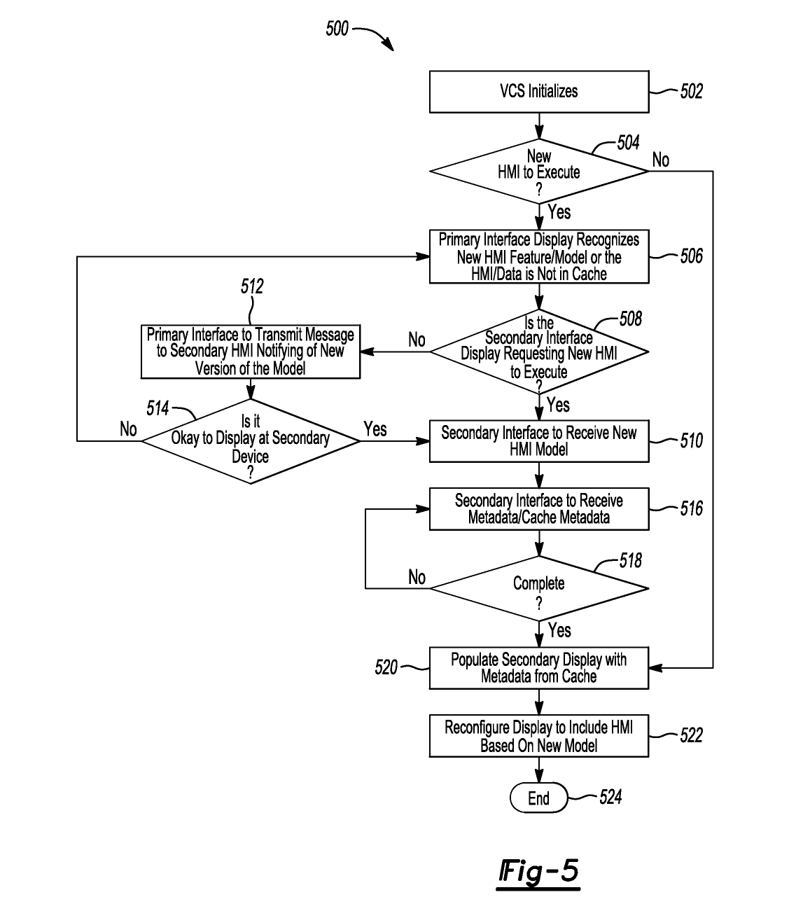

FIG. 5 is a flow chart illustrating an example method 500 of a primary interactive display configuring one or more secondary displays in a vehicle computing system. The method 500 is implemented using software code executed with hardware embedded within the vehicle infotainment module. In other embodiments, the method 500 is implemented in other vehicle controllers, or distributed amongst multiple vehicle controllers.

Referring again to FIG. 5, the vehicle and its components illustrated in FIG. 1, FIG. 2, FIG. 3 and FIG. 4 are referenced throughout the discussion of the method 500 to facilitate understanding of various aspects of the present disclosure. The method 500 of reconfiguring one or more displays in the infotainment system may be implemented through a computer algorithm, machine executable code, or software instructions programmed into a suitable programmable logic device(s) of the vehicle, such as the vehicle infotainment module, the display module, another controller in communication with the vehicle computing system, or a combination thereof. Although the various steps shown in the flowchart diagram appear to occur in a chronological sequence, at least some of the steps may occur in a different order, and some steps may be performed concurrently or not at all.

At step 502, during a key-on event which allows the vehicle to be powered on, the VCS may begin powering up the one or more modules. The powering up of the one or more modules may cause variables related to the infotainment system to initialize before enabling one or more algorithms used to manage data to output at the one or more displays.

At step 504, the one or more displays in communication with the VCS may request if any new HMI and/or model (i.e., logic) data is available for output. The primary user inter display may recognize one or more HMI features that may be considered new features at step 506.

For example, the primary user interface may recognize a menu interface for selecting an audio track from a music metadata database. The primary user interface may receive the music metadata database HMI data. The primary user interface may output a new HMI menu display based on the music metadata database that allows a user to select an audio track for playing based on certain criteria such as artist, track title, album title, etc. . . . .

In another example, the primary user interface may receive a display screen worth of data at a time from the VCS as the model being downloaded requested the data to fill in fields in the model. The VCS may transmit the model at runtime to one or more secondary displays.

At step 508, a secondary interface display may request new HMI/model data to execute based on one or more selected criteria. The one or more selected criteria may include, but is not limited to, a user setting, predefined calibration settings, and/or a combination thereof. For example, a user may define a system setting so that music data may be transmitted to the vehicle dash display and/or the heads-up display to view information received at the primary user interface. An example of a predefined calibration setting may include a limited amount of text data transmitted to the vehicle dash display during certain driving maneuvers (e.g., vehicle speed is greater than 35 mph).

At step 512, if the one or more selected criteria prevent automatic execution of the new HMI to be executed at the secondary interface display, the primary interface may transmit a message to the secondary HMI notifying of the new HMI feature. The secondary interface may reconfigure its display at a later time when the VCS determines, based on a predefined criteria, that it is acceptable to reconfigure the display at step 514.

At step 510, the secondary interface may receive the new HMI feature to begin reconfiguration of the display. The secondary interface may receive metadata/cache metadata at step 516. The secondary interface may continue to receive the new HMI feature data until the reconfiguration is complete at step 518.

For example, during system startup, a message to the secondary interface may be received notifying of a new model. The secondary device may receive parts of the model that are needed, or it may receive a download form the VCS of the entire model.

At step 520, the secondary interface may begin to populate the display of the new HMI feature based on metadata from cache. The secondary interface may output a reconfigured display to include the new HMI feature at step 522. Continuing form the example above, the primary user interface may communicate the menu interface data to a secondary user interface. The secondary user interface may include, but is not limited to, a vehicle dash display, a heads-up display, and/or rear seat displays. The secondary user interface may receive the menu interface data and reconfigure the display to output the data. The secondary user interface may output the music menu interface including the album art, title, track, time of track, and/or time remaining on the track.

At step 524, the vehicle computing system may have a vehicle key-off mode to allow the system to store one or more HMI datasets in nonvolatile memory such that these datasets may be used by the system for the next key-on event.

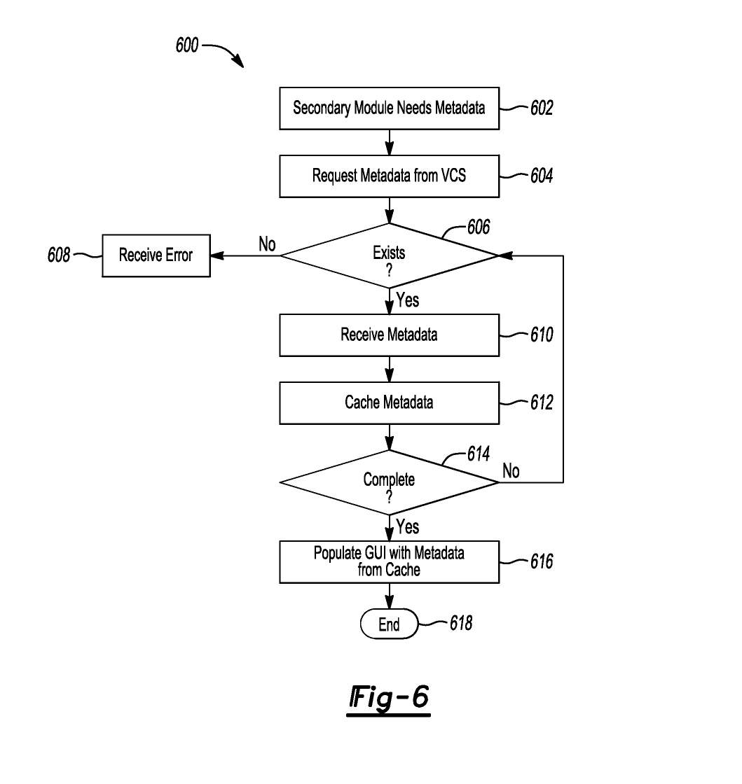

FIG. 6 is a flow chart illustrating the management 600 of data between one or more modules in a vehicle computing system according to an embodiment. The infotainment system may have one or more secondary displays (e.g., dash display, heads-up display, etc. . . . ) that may make a request to the VCS for a static image whenever a static image is needed for display on the HMI/GUI.

At step 602, the one or more secondary displays are initialized and determine the needs for metadata to present information at the display(s). The secondary display(s) communicates a request for metadata to the VCS.

For example, the metadata (e.g., static images) may be stored on the VCS or on a brought-in device communicating with the VCS. If the requested metadata is not stored on the VCS, the VCS may retrieve the metadata form the appropriate brought-in device before transmitting to the requesting module at step 606. If no data is receive, the VCS may communicate an error to the secondary display at step 608.

At step 610, the secondary display may receive the metadata. The secondary display may store the metadata in a metadata cache at step 612. The secondary display may continue to receive and cache metadata until the download is complete at step 614.

At step 616, the secondary display may populate the HMI/GUI with metadata from the cache. The vehicle computing system may have a vehicle key-off mode to allow the system to store one or more HMI/GUI data in nonvolatile memory such that the data may be used by the system for the next key-on event at step 618.

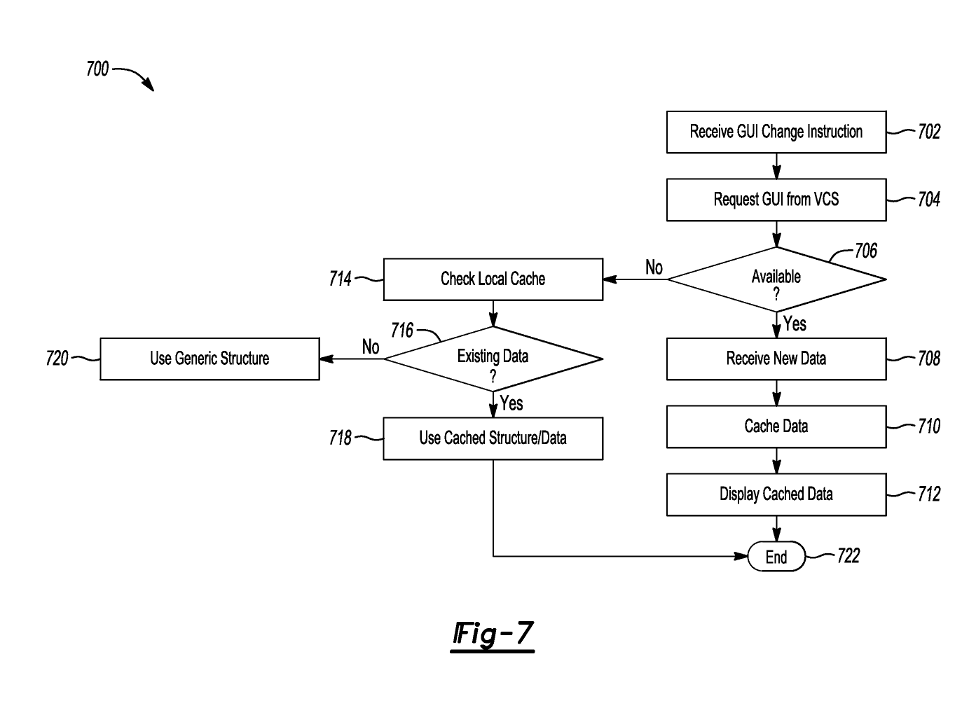

FIG. 7 is a flow chart illustrating the management of graphical user interface data 700 in a vehicle computing system according to an embodiment. The VCS may have a management strategy of communicating data to and from one or more displays using a high speed network. The VCS may manage the data received at a primary user interface and communicate the data to one or more secondary displays.

At step 702, the secondary display may receive a GUI change instruction. The secondary display may request the GUI change from the VCS at step 704.

For example, the primary user interface display may receive instruction regarding a new destination location. The VCS may receive graphical moving map data and communicate a GUI change to the one or more secondary devices.

At step 706, the VCS may determine if there is data related to the GUI change request. If no new data related to the GUI change, the secondary display may check local cache at step 714. The secondary display may determine if there is existing data related to the GUI change at step 716. If there is no existing data, the secondary display may use the generic structure to output at the display at step 720. If there is existing data, the secondary display may use the cached structure/data and present the GUI change at the display at step 718.

At step 708, the VCS determines that there is new data related to the GUI change request, the secondary display may receive the new data. The secondary display may cache data at step 710. The secondary display may output the cached data causing the GUI change to be displayed. The VCS and secondary display may have a vehicle key-off mode to allow the system to store one or more HMI/GUI data in nonvolatile memory such that the data may be used by the system for the next key-on event at step 722.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and can be desirable for particular applications.

What is claimed is:

1. A method for managing display data in a vehicle computing system having one or more controllers communicating in an Ethernet network, the method comprising:
establishing communication with a remote server using a transceiver;
receiving a display configuration for a primary interface at the transceiver from the remote server;
outputting the display configuration at the primary interface;
communicating the display configuration to a vehicle dash display;
reconfiguring the vehicle dash display based on the display configuration; and
outputting the display configuration at the vehicle dash display.

2. The method of claim 1, wherein the vehicle dash display is a driver instrument panel.

3. The method of claim 1, wherein the primary interface includes one or more virtual machines and virtual embedded control units for managing the display configuration to the vehicle day display.

4. The method of claim 1, wherein the primary interface is a center stack display.

5. The method of claim 1, further comprising the transceiver establishing communication with a nomadic device.

6. The method of claim 5, wherein the nomadic device is used to establish communication between the one or more controllers and the remote server.

7. The method of claim 1, wherein the display configuration includes at least one of HMI definition, runnable model, and sandboxed code.

8. A vehicle infotainment system comprising:
one or more controllers having a transceiver to communicate with at least one data source, the one or more controllers configured to:
receive graphical user interface data at a first interactive display from the at least one data source;
communicate the graphical user interface data to a heads-up display;
reconfigure the heads-up display based on the graphical user interface; and
output the graphical user interface data at the heads-up display.

9. The vehicle infotainment system of claim 8, wherein the graphical user interface data is navigation information.

10. The vehicle infotainment system of claim 8, wherein the graphical user interface data includes at least one of media information, phone, applications, hard buttons, and voice commands.

11. The vehicle infotainment system of claim 8, wherein the one or more controllers are further configured to communicate with a nomadic device to receive the at least one data source.

12. The vehicle infotainment system of claim 11, wherein the one or more controllers are further configured to establish communication with a remote server using the nomadic device to receive the at least one data source.

13. The vehicle infotainment system of claim 12, wherein the one or more controllers are further configured to receive graphical user interface data from the remote server and transmit it to the first interactive display.

14. A non-transitory computer readable storable medium, storing instruction that, when executed by a processor, configure the processor to:
establish a communication connection with a vehicle navigation system;
receive graphical moving map data from the navigation system at a primary interface;
stream the graphical moving map data to a vehicle dash display;
update the vehicle dash display based on the graphical moving map data; and
output the graphical moving map data at the vehicle dash display.

15. The non-transitory computer readable storable medium of claim 14, wherein the stored instructions further configure the processor to communicate with an embedded cell phone.

16. The non-transitory computer readable storable medium of claim 15, wherein the embedded cell phone establishes communication with a remote server.

17. The non-transitory computer readable storable medium of claim 16, wherein the remote server hosts a navigation system.

18. The non-transitory computer readable storable medium of claim 14, wherein the vehicle dash display is a driver instrument cluster having at least one of gauges, heads-up display, and a liquid crystal display.

19. The non-transitory computer readable storable medium of claim 14, wherein graphical moving map data is related to at least one of a specific destination, traffic, and a predictive navigation destination.

20. The non-transitory computer readable storable medium of claim 14, wherein the graphical moving map data is related to at least one of parking availability, a scheduled meeting, and a weather report.
